(19) United States
(12) Patent Application Publication
(10) Pub. No.: US 2026/0074117 A1
(43) Pub. Date: Mar. 12, 2026

(54) MULTILAYER CERAMIC CAPACITOR

(71) Applicant: Murata Manufacturing Co., Ltd., Nagaokakyo-shi (JP)

(72) Inventors: Kazuya TAGA, Nagaokakyo-shi (JP); Kazuhisa UCHIDA, Nagaokakyo-shi (JP)

(21) Appl. No.: 19/307,114

(22) Filed: Aug. 22, 2025

(30) Foreign Application Priority Data
Sep. 12, 2024 (JP) 2024-158048

(51) Int. Cl. H01G 4/232; H01G 2/06; H01G 4/008; H01G 4/012; H01G 4/12; H01G 4/30

(52) U.S. Cl. CPC H01G 4/232; H01G 2/065; H01G 4/008; H01G 4/012; H01G 4/12; H01G 4/30

(57) ABSTRACT

A multilayer ceramic capacitor includes a multilayer body and an outer electrode. The outer electrode includes an inner base electrode, an outer base electrode, and a plating layer. The inner base electrode is on at least one of first and second end surfaces and includes glass and conductive metal. The outer base electrode is on the inner base electrode and includes glass and conductive metal. The outer base electrode includes, as a main metal component, a component different from a main metal component of the inner base electrode. The plating layer is on the outer base electrode.

### CROSS REFERENCE TO RELATED APPLICATIONS

This application claims the benefit of priority to Japanese Patent Application No. 2024-158048 filed on Sep. 12, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor is one of the important components in electronic devices, such as mobile terminals and precision instruments. To improve the performance of electronic devices and achieve reliable machine operation, there is an urgent need for multilayer ceramic capacitors with improved reliability.

One of the crucial factors related to the reliability of multilayer ceramic capacitors is the reliability regarding resistance to corrosives. Japanese Unexamined Patent Application Publication No. 2023-98638 describes a technology for improving the reliability of a multilayer ceramic capacitor regarding resistance to corrosives.

The reliability regarding electrical connection, such as the reliability of connection between inner and outer electrodes, is another factor that is related to the reliability of multilayer ceramic capacitors and that is as important as the reliability regarding resistance to corrosives. However, in the multilayer ceramic capacitor according to Japanese Unexamined Patent Application Publication No. 2023-98638, no measure is disclosed to improve the reliability regarding electrical connection. It is desirable to develop a multilayer ceramic capacitor with high reliability regarding resistance to corrosives and also with high reliability regarding electric connection.

### SUMMARY OF THE INVENTION

Example embodiments of the present invention provide multilayer ceramic capacitors each with improved reliability.

A multilayer ceramic capacitor according to an example embodiment of the present invention includes a multilayer body and an outer electrode. The multilayer body includes dielectric layers and inner electrodes that are laminated. The multilayer body includes a first principal surface and a second principal surface opposed to each other in a lamination direction, a first side surface and a second side surface opposed to each other in a width direction crossing the lamination direction, and a first end surface and a second end surface opposed to each other in a length direction crossing the lamination direction and the width direction. The outer electrode is provided on the multilayer body and connected to the inner electrodes. The outer electrode includes an inner base electrode, an outer base electrode, and a plating layer. The inner base electrode is provided on at least one of the first end surface and the second end surface and includes glass and conductive metal. The outer base electrode is provided on the inner base electrode and includes glass and conductive metal. The outer base electrode includes, as a main metal component, a metal component different from a main metal component of the inner base electrode. The plating layer is provided on the outer base electrode. The outer base electrode includes an outer diffusion portion including the main metal component of the inner base electrode with a content of about 1/10 or more of a content of the main metal component of the outer base electrode in the outer base electrode. The outer diffusion portion is adjacent to the inner base electrode. The outer diffusion portion has a maximum thickness of about 1.0 μm or less.

According to example embodiments of the present invention, multilayer ceramic capacitors each with improved reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a sectional view of FIG. 1 taken along line II-II.

FIG. 3 is a sectional view of FIG. 1 taken along line III-III.

FIG. 4 is an enlarged view of portion IV in FIG. 2.

FIG. 5 is a graph showing the result of EDX measurement of an inner base electrode and an outer base electrode.

### DETAILED DESCRIPTION OF THE EXAMPLE EMBODIMENTS

Example embodiments of the present invention will be described in detail below with reference to the drawings.

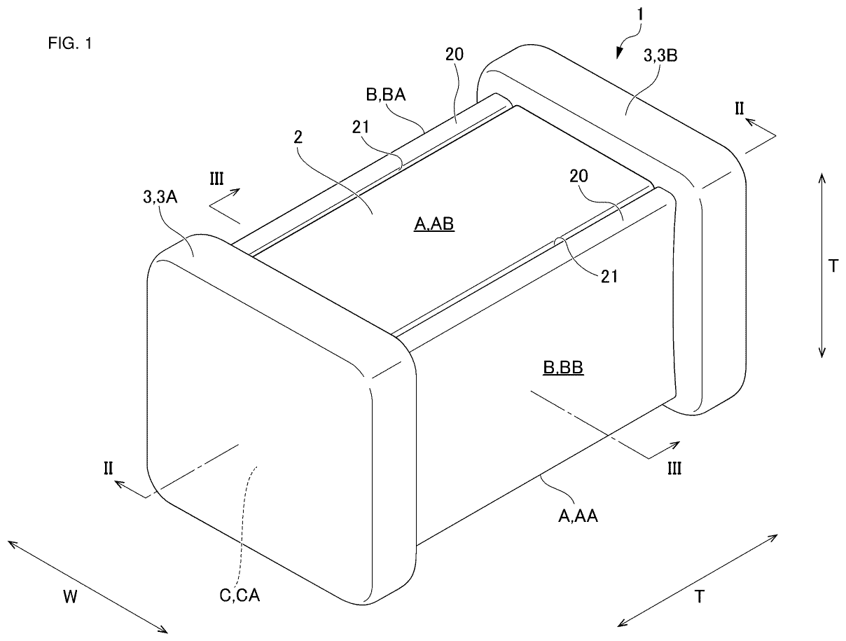

Multilayer ceramic capacitors 1 according to example embodiments of the present invention will be described with reference to FIGS. 1 to 4.

### Multilayer Ceramic Capacitor

As illustrated in FIG. 1, the multilayer ceramic capacitor 1 is a multilayer ceramic capacitor having a two-terminal structure. The multilayer ceramic capacitor 1 includes a multilayer body 2 and a pair of outer electrodes 3. The multilayer body 2 is has a rectangular or substantially rectangular parallelepiped shaped and includes six outer surfaces. The multilayer body 2 includes an inner layer portion 11 in which dielectric layers 14 and inner electrodes 15 are laminated.

In this specification, a direction in which the dielectric layers 14 and the inner electrodes 15 are laminated in the multilayer ceramic capacitor 1 is referred to as a lamination direction T. A direction orthogonal or substantially orthogonal to the lamination direction T is referred to as a length direction L. A direction orthogonal or substantially orthogonal to both the length direction L and the lamination direction T is referred to as a width direction W.

Of the six outer surfaces of the multilayer body 2, a pair of outer surfaces at both sides in the lamination direction T is referred to as a first principal surface AA and a second principal surface AB, a pair of outer surfaces extending in the lamination direction T at both sides in the width direction W as a first side surface BA and a second side surface BB, and a pair of outer surfaces extending in the lamination direction T at both sides in the length direction L as a first end surface CA a second end surface CB.

The first principal surface AA and the second principal surface AB may be referred to collectively as “principal surfaces A”. The first side surface BA and the second side surface BB may be referred to collectively as “side surfaces B”. The first end surface CA and the second end surface CB may be referred to collectively as “end surfaces C”.

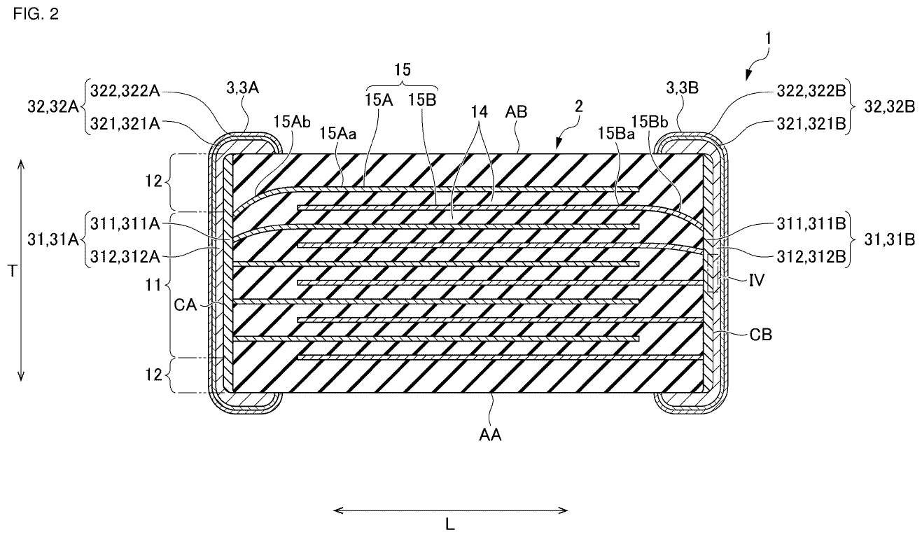

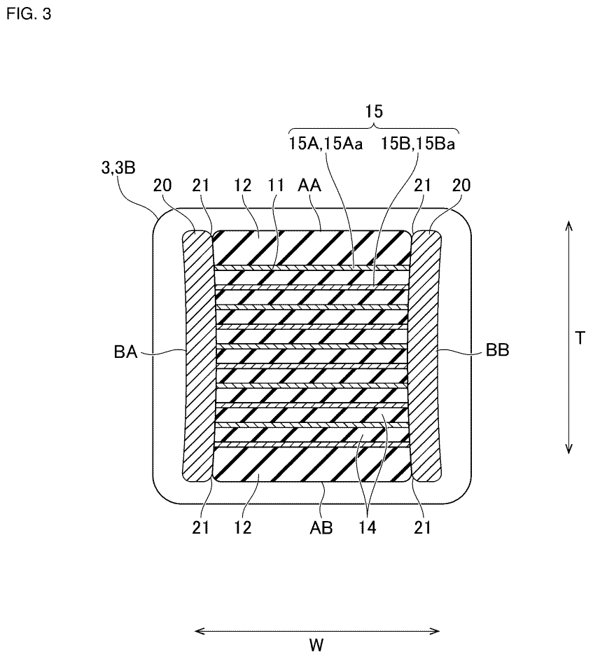

A cross section along a plane parallel or substantially parallel to the lamination direction T and the length direction L is referred to as an “LT cross section”. The cross section illustrated in FIG. 2 is an LT cross section passing through a central portion of the multilayer ceramic capacitor 1 in the width direction W. A cross section along a plane parallel or substantially parallel to the lamination direction T and the width direction W is referred to as a “WT cross section”. The cross section illustrated in FIG. 3 is a WT cross section passing through a central portion of the multilayer ceramic capacitor 1 in the length direction L.

### Multilayer Body

The multilayer body 2 includes the inner layer portion 11 in which the dielectric layers 14 and the inner electrodes 15 are laminated, outer layer portions 12 that sandwich the inner layer portion 11 in the lamination direction T, and side margin portions 20 that sandwich the inner layer portion 11 and the outer layer portions 12 in the width direction W. Portions of the multilayer body 2 at which three outer surfaces intersect are referred to as “corner portions”. Portions of the multilayer body 2 at which two outer surfaces intersect are referred to as “ridge portions”. The corner portions and the ridge portions of the multilayer body 2 are preferably rounded.

### Inner Layer Portion

As illustrated in FIGS. 2 and 3, the inner layer portion 11 includes the dielectric layers 14 and the inner electrodes 15. The dielectric layers 14 and the inner electrodes 15 are alternately laminated.

The dielectric layers 14 include a perovskite-structured compound. The material of the dielectric layers 14 may be, for example, a dielectric ceramic material including BaTiO3, CaTiO3, SrTiO3, or CaZrO3 as the main component. In addition to the main component, the material of the dielectric layers 14 may additionally include, for example, a Mn compound, a Mg compound, a Si compound, a Fe compound, a Cr compound, a Co compound, a Ni compound, an Al compound, a V compound, or a rare-earth compound as an accessory component. The average grain diameter of the dielectric layers 14 is, for example, about 0.05 μm or more and about 0.15 μm or less.

The inner electrodes 15 are formed by sintering conductive paste including metal powder that defines and functions as a conductor, an organic solvent, a binder, and a dispersant on the dielectric layers 14. Examples of the metal powder that defines and functions as a conductor include Ni, Cu, Ag, Pd, an Ag—Pd alloy, Au, Sn, or other metals. These metals may be compounds including the above-described metal elements or alloys with other metals. The main metal component of the inner electrodes 15 is, for example, Ni. The total number of inner electrodes 15 is, for example, 100 or more and 500 or less. The main metal component of the inner electrodes 15 is defined as one of the metals included in the inner electrodes 15 with the highest content.

The inner electrodes 15 include a plurality of first inner electrodes 15A and a plurality of second inner electrodes 15B. The first inner electrodes 15A are exposed only at the first end surface CA. The second inner electrodes 15B are exposed only at the second end surface CB. The first inner electrodes 15A and the second inner electrodes 15B are alternately arranged.

One of the inner electrodes 15 that is closest to the first principal surface AA is, for example, one of the first inner electrodes 15A. One of the inner electrodes 15 that is closest to the second principal surface AB is, for example, one of the second inner electrodes 15B. However, this is not a limitation. One of the inner electrodes 15 that is closest to the first principal surface AA may be one of the second inner electrodes 15B, and one of the inner electrodes 15 that is closest to the second principal surface AB may be one of the first inner electrodes 15A.

Each first inner electrode 15A includes a first facing portion 15Aa and a first extended portion 15Ab. The first facing portion 15Aa is a portion of the first inner electrode 15A that faces the second inner electrode 15B adjacent to the first inner electrode 15A. The first extended portion 15Ab is a portion of the first inner electrode 15A that extends from the first facing portion 15Aa toward a first outer electrode 3A. The first extended portion 15Ab is exposed at the first end surface CA. The first extended portion 15Ab is electrically connected to the first outer electrode 3A.

Each second inner electrode 15B includes a second facing portion 15Ba and a second extended portion 15Bb. The second facing portion 15Ba is a portion of the second inner electrode 15B that faces the first inner electrode 15A (first facing portion 15Aa) adjacent to the second inner electrode 15B. The second extended portion 15Bb is a portion of the second inner electrode 15B that extends toward a second outer electrode 3B. The second extended portion 15Bb is exposed at the second end surface CB. The second extended portion 15Bb is electrically connected to the second outer electrode 3B.

The first inner electrodes 15A and the second inner electrodes 15B may be referred to collectively as “inner electrodes 15”. The first facing portions 15Aa and the second facing portions 15Ba may be referred to collectively as “facing portions 15a”. The first extended portions 15Ab and the second extended portions 15Bb may be referred to collectively as “extended portions 15b”.

### Outer Layer Portions

The outer layer portions 12 are, for example, made of the same material as the material of the dielectric layers 14 of the inner layer portion 11. No inner electrodes 15 are provided in the outer layer portions 12.

### Side Margin Portions

The side margin portions 20 are, for example, made of the same material as the material of the dielectric layers 14 of the inner layer portion 11. The side margin portions 20 sandwich the inner layer portion 11 and the outer layer portions 12 in the width direction W.

### Outer Electrodes

The outer electrodes 3 are provided on the multilayer body 2. More specifically, the outer electrodes 3 are provided on the end surfaces C. The outer electrodes 3 are connected to the inner electrodes 15. The outer electrodes 3 include the first outer electrode 3A provided on the first end surface CA and connected to the first inner electrodes 15A and the second outer electrode 3B provided on the second end surface CB and connected to the second inner electrodes 15B. The first outer electrode 3A covers not only the first end surface CA but also portions of the principal surfaces A and portions of the side surfaces B. The second outer electrode 3B covers not only the second end surface CB but also portions of the principal surfaces A and portions of the side surfaces B.

The outer electrodes 3 include an inner base electrode 311, an outer base electrode 312, and a plating layer 32. The inner base electrode 311 is provided on at least one of the first end surface CA and the second end surface CB and includes glass and conductive metal. The outer base electrode 312 is provided on the inner base electrode 311 and includes glass and conductive metal. The outer base electrode 312 includes, as a main metal component, a component different from a main metal component of the inner base electrode 311. The plating layer 32 is provided on the outer base electrode 312. The plating layer 32 includes, for example, an inner plating layer 321 provided on the outer base electrode 312 and an outer plating layer 322 provided on the inner plating layer 321.

The inner base electrode 311 includes an inner diffusion portion 311a that is a region including the main metal component of the outer base electrode 312 with a content of about 1/10 or more of the content of the main metal component of the inner base electrode 311 in the inner base electrode 311. The inner diffusion portion 311a is adjacent to the outer base electrode 312. However, the inner diffusion portion 311a is not necessary.

The inner base electrode 311 is, for example, a baked layer. Of the outer surfaces of the multilayer body 2, the inner base electrode 311 is provided only on, for example, the end surface C, and is not provided on portions of the principal surfaces A or portions of the side surfaces B. The inner base electrode 311 has a thickness of, for example, about 5 μm or more and about 10 μm or less. The glass content of the inner base electrode 311 is, for example, about 5% or more and about 10% or less. The inner base electrode 311 includes, for example, Cu, Sn, Zn, Ni, Ag, Pd, Au, or an Ag—Pd alloy. The main metal component of the inner base electrode 311 is defined as one of the metals included in the inner base electrode 311 with the highest content.

The outer base electrode 312 is, for example, a baked layer. The outer base electrode 312 is, for example, provided on the first end surface CA, portions of the principal surfaces A, and portions of the side surfaces B. The outer base electrode 312 has a thickness of, for example, about 5.5 μm or more and about 20 μm or less. The glass content of the outer base electrode 312 is, for example, about 15% or more and about 30% or less. The outer base electrode 312 includes, for example, Cu, Sn, Zn, Ni, Ag, Pd, Au, or an Ag—Pd alloy. However, the main metal component of the outer base electrode 312 differs from the main metal component of the inner base electrode 311. The main metal component of the outer base electrode 312 is defined as one of the metals included in the outer base electrode 312 with the highest content.

The inner base electrode 311 and the outer base electrode 312 may be referred to collectively as “base electrodes 31”.

The plating layer 32 includes, for example, one metal of Cu, Ni, Ag, Pd, Au, or Sn, or an alloy including the metal. The inner plating layer 321 is, for example, a Ni plating layer. The outer plating layer 322 is, for example, a Sn plating layer. The plating layer 32 may have a single layer structure. Each layer included in the plating layer 32 preferably has a thickness of, for example, about 2 μm or more and about 7 μm or less.

The first outer electrode 3A includes a first inner base electrode 311A, a first outer base electrode 312A, and a first plating layer 32A. The first inner base electrode 311A is provided on the first end surface CA and includes glass and conductive metal. The first outer base electrode 312A is provided on the first inner base electrode 311A and includes glass and conductive metal. The first outer base electrode 312A includes, as a main metal component, a component different from a main metal component of the first inner base electrode 311A. The first plating layer 32A is provided on the first outer base electrode 312A. The first plating layer 32A includes, for example, a first inner plating layer 321A provided on the first outer base electrode 312 and a first outer plating layer 322A provided on the first inner plating layer 321A.

The second outer electrode 3B includes a second inner base electrode 311B, a second outer base electrode 312B, and a second plating layer 32. The second inner base electrode 311B is provided on the second end surface CB and includes glass and conductive metal. The second outer base electrode 312B is provided on the second inner base electrode 311B and includes glass and conductive metal. The second outer base electrode 312B includes, as a main metal component, a component different from a main metal component of the second inner base electrode 311B. The second plating layer 32B is provided on the second outer base electrode 312B. The second plating layer 32B includes, for example, a second inner plating layer 321B provided on the second outer base electrode 312B and a second outer plating layer 322B provided on the second inner plating layer 321B.

The second outer electrode 3B has, for example, a structure the same or substantially the same as the structure of the first outer electrode 3A. Therefore, description of the second outer electrode 3B may be omitted. The second inner base electrode 311B corresponds to the first inner base electrode 311A, the second outer base electrode 312B to the first outer base electrode 312A, and the second plating layer 32B to the first plating layer 32A.

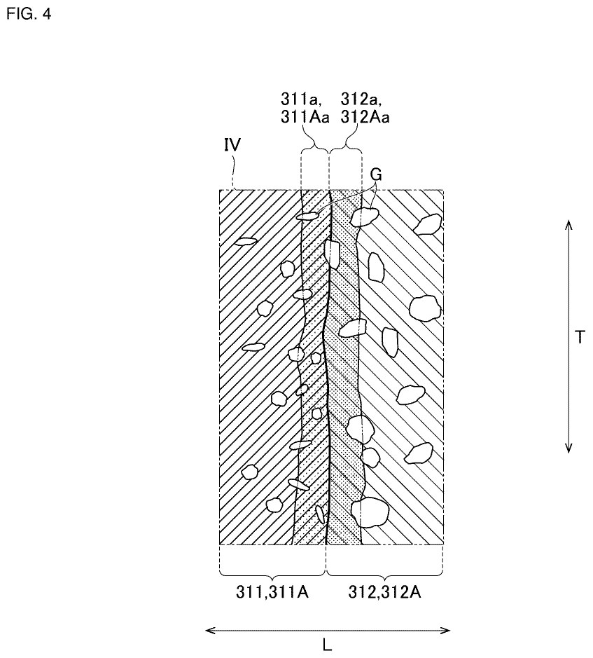

As illustrated in FIG. 4, the outer base electrode 312 includes an outer diffusion portion 312a that is a region including the main metal component of the inner base electrode 311 with a content of about 1/10 or more of the content of the main metal component of the outer base electrode 312 in the outer base electrode 312. The outer diffusion portion 312a is adjacent to the inner base electrode 311. The outer diffusion portion 312a has a maximum thickness of, for example, about 1.0 μm or less.

For example, the first outer base electrode 312A includes a first outer diffusion portion 312Aa that is a region including the main metal component of the first inner base electrode 311A with a content of about 1/10 or more of the content of the main metal component of the first outer base electrode 312A in the first outer base electrode 312A. The first outer diffusion portion 312Aa is adjacent to the inner base electrode 311. The first outer diffusion portion 312Aa has a maximum thickness of, for example, about 1.0 μm or less.

The main metal component of the inner base electrode 311 is, for example, preferably at least one metal of Ni, Ag, or Pd, and the main metal component of the outer base electrode 312 is, for example, preferably at least one metal of Cu, Sn, or Zn. More preferably, the main metal component of the inner base electrode 311 is, for example, Ni, and the main metal component of the outer base electrode 312 is, for example, Cu. Preferably, the main metal component of the inner base electrode 311 is the same or substantially the same as the main metal component of the inner electrodes 15.

For example, the main metal component of the first inner base electrode 311A is, for example, preferably at least one metal of Ni, Ag, or Pd, and the main metal component of the first outer base electrode 312A is, for example, preferably at least one metal of Cu, Sn, or Zn. More preferably, for example, the main metal component of the first inner base electrode 311A is Ni, and the main metal component of the first outer base electrode 312A is Cu.

The inner base electrode 311 has a maximum thickness less than the maximum thickness of the outer base electrode 312.

For example, the first inner base electrode 311A has a maximum thickness less than the maximum thickness of the first outer base electrode 312A.

The minimum distance from one point on an inner surface (surface joined to the multilayer body 2) of the inner base electrode 311 to an outer surface (surface joined to the outer base electrode 312) of the inner base electrode 311 is defined as the thickness of the inner base electrode 311 at the point. The minimum distance from one point on an inner surface (surface joined to the inner base electrode 311) of the outer base electrode 312 to an outer surface (surface joined to the plating layer 32) of the outer base electrode 312 is defined as the thickness of the outer base electrode 312 at the point.

The ratio of the maximum thickness of the inner base electrode 311 to the maximum thickness of the outer base electrode 312 is, for example, about 0.5 or more and about 0.9 or less.

For example, the ratio of the maximum thickness of the first inner base electrode 311A to the maximum thickness of the first outer base electrode 312A is, for example, about 0.5 or more and about 0.9 or less.

The glass content of the inner base electrode 311 is less than the glass content of the outer base electrode 312.

For example, the glass content of the first inner base electrode 311A is less than the glass content of the first outer base electrode 312A.

The ratio of the glass content of the inner base electrode 311 to the glass content of the outer base electrode 312 is, for example, about 0.33 or more and about 0.66 or less.

For example, the ratio of the glass content of the first inner base electrode 311A to the glass content of the first outer base electrode 312A is, for example, about 0.33 or more and about 0.66 or less.

When a portion of the inner base electrode 311 provided on the first end surface CA is evenly divided into three regions in the length direction L in a LT cross section, the glass content in one of the three regions that is closest to the outer base electrode 312 is greater than the glass content in the central one of the three regions.

In addition, the inner electrodes 15 satisfy a relationship in which end portions of every adjacent pair of the inner electrodes 15 on one side in the width direction W are at a distance of, for example, about 0.5 μm or less from each other in the width direction W. The inner electrodes 15 satisfy a relationship in which end portions of every adjacent pair of the inner electrodes 15 on the other side in the width direction W are at a distance of, for example, about 0.5 μm or less from each other in the width direction W.

The multilayer body 2 includes recessed portions 21 in outer surfaces of the multilayer body 2 in regions overlapping, in the lamination direction T, the end portions of the inner electrodes 15 in the width direction W. The recessed portions 21 are recessed toward a central portion of the multilayer body 2 in the lamination direction T.

The recessed portions 21 are, for example, provided in the outer surface of the first principal surface AA in a region overlapping, in the lamination direction T, the end portions of the inner electrodes 15 in the width direction W that are adjacent to the first side surface BA, the outer surface of the first principal surface AA in a region overlapping, in the lamination direction T, the end portions of the inner electrodes 15 in the width direction W that are adjacent to the second side surface BB, the outer surface of the second principal surface AB in a region overlapping, in the lamination direction T, the end portions of the inner electrodes 15 in the width direction W that are adjacent to the first side surface BA, and the outer surface of the second principal surface AB in a region overlapping, in the lamination direction T, the end portions of the inner electrodes 15 in the width direction W that are adjacent to the second side surface BB. The recessed portions 21 extend, for example, over the entire or substantially the entire region of the multilayer body 2 in the length direction L. The end portions of the recessed portions 21 in the length direction L overlap the outer electrodes 3.

The recessed portions 21 may be provided only on the first principal surface AA or only on the second principal surface AB. In such a case, the first principal surface AA and the second principal surface AB of the multilayer ceramic capacitor 1 can be easily distinguished from each other. Therefore, the multilayer ceramic capacitor 1 can be easily mounted on a substrate in an orientation such that the second principal surface AB faces the substrate.

The dielectric layers 14 include pores (voids). The dielectric layers 14 preferably have a porosity (void fraction) of, for example, about 1% or more and about 5% or less. Portions of the dielectric layers 14 facing the inner electrodes 15 in the lamination direction T preferably have a porosity of, for example, about 1% or more and about 5% or less. The porosity means the percentage of voids present in the dielectric layers 14.

The dimension of the multilayer body 2 in the width direction W at the central portion of the multilayer body 2 in the lamination direction T is less than the dimensions of the multilayer body 2 in the width direction W at the end portions of the multilayer body 2 in the lamination direction T. When viewed in the length direction L, the first side surface BA has an arc shape such that a middle portion of the first side surface BA in the lamination direction T is convex toward the central portion of the multilayer body 2 in the width direction W. When viewed in the length direction L, the second side surface BB has an arc shape such that a middle portion of the second side surface BB in the lamination direction T is convex toward the central portion of the multilayer body 2 in the width direction W.

When viewed in the length direction L, a line connecting the end portions of all of the inner electrodes 15 on one side in the width direction W has an arc shape that is convex toward the central portion of the multilayer body 2 in the width direction W. When viewed in the length direction L, a line connecting the end portions of all of the inner electrodes 15 on the other side in the width direction W has an arc shape that is convex toward the central portion of the multilayer body 2 in the width direction W. In other words, when viewed in the length direction L, faces of the inner layer portion 11 facing the side margin portions 20 have arc shapes that are convex toward the central portion of the multilayer body 2 in the width direction W.

In an LT cross section passing through the central portion of the multilayer body 2 in the width direction W, the extended portion 15b of one of the inner electrodes 15 that is closest to the first principal surface AA has a curvature greater than the curvature of the extended portion 15b of one of the inner electrodes 15 that is closest to the second principal surface AB.

For example, in the LT cross section passing through the central portion of the multilayer body 2 in the width direction W, the extended portion 15b (more specifically, the first extended portion 15Ab) of one of the inner electrodes 15 (more specifically, the first inner electrode 15A) that is closest to the first principal surface AA is curved to approach the central portion of the multilayer body 2 in the lamination direction T toward the second end surface CB. The extended portion 15b (more specifically, the second extended portion 15Bb) of one of the inner electrodes 15 (more specifically, the second inner electrode 15B) that is closest to the second principal surface AB is not curved in the lamination direction T or is slightly curved to approach the central portion of the multilayer body 2 in the lamination direction T toward the first end surface CA.

The dimension of the multilayer body 2 in the lamination direction T is greater than the dimension of the multilayer body 2 in the width direction W. The dimension of the multilayer body 2 in the length direction L is, for example, about 0.6 mm or more and about 1.2 mm or less. The dimension of the multilayer body 2 in the width direction W is, for example, about 0.3 mm or more and about 0.6 mm or less. The dimension of the multilayer body 2 in the lamination direction T is, for example, about 0.3 mm or more and about 0.6 mm or less.

It is not necessary that the dimension of the multilayer body 2 in the lamination direction T is greater than the dimension of the multilayer body 2 in the width direction W. The dimension of the multilayer body 2 in the lamination direction T may be less than or equal to the dimension of the multilayer body 2 in the width direction W.

### Measurement Methods

Examples of methods for measuring various parameters will now be described.

### Contents of Metal Elements

The contents of metal elements are determined by polishing the multilayer ceramic capacitor 1 to expose a predetermined cross section and performing an EDX measurement on the cross section. The predetermined cross section is an LT cross section passing through a central portion of the multilayer ceramic capacitor 1 in the width direction W.

The position of the boundary between the inner base electrode 311 and the outer base electrode 312, the area of the inner diffusion portion 311a, and the area of the outer diffusion portion 312a can be determined based on the results of the EDX measurement. An example of a method for determining the position of the boundary between the inner base electrode 311 and the outer base electrode 312, the area of the inner diffusion portion 311a, and the area of the outer diffusion portion 312a will now be described.

First, in the LT cross section of the multilayer ceramic capacitor 1, the position in the lamination direction T is maintained constant, and the relationships between the minimum distance from a measurement point to the outer surface of the multilayer body 2 and the contents of metal elements at the measurement point are determined.

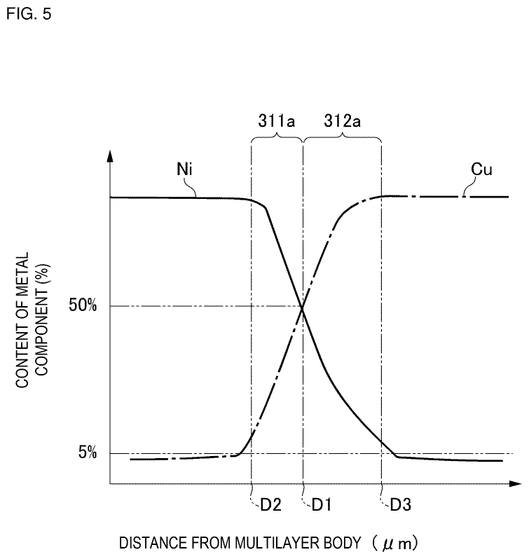

FIG. 5 is a graph showing the result of the EDX analysis performed on the inner base electrode 311 and the outer base electrode 312. FIG. 5 shows the relationship between the minimum distance from the measurement point to the outer surface of the multilayer body 2 and the content of each metal element at the measurement point. In FIG. 5, the horizontal axis represents the minimum distance from the measurement point to the outer surface of the multilayer body 2, and the vertical axis represents the content of each metal element at the measurement point. Among the measurement results of various metal elements, only the measurement results of Ni and Cu are shown in FIG. 5 for convenience of description. However, in practice, various metal elements other than Ni and Cu are also measured. In addition, when granular glass is present at a measurement point, the measurement values for the measurement point are discarded. Therefore, the curves showing the results of the EDX analysis may be partially disconnected.

In a region close to the outer surface of the multilayer body 2 in the inner base electrode 311 and the outer base electrode 312 (see the region close to the left end of the graph in FIG. 5), the content of Ni is the highest among the contents of metal elements. The main metal component of the inner base electrode 311 is Ni.

In a region close to the plating layer 32 in the inner base electrode 311 and the outer base electrode 312 (see the region close to the right end of the graph in FIG. 5), the content of Cu is the highest among the contents of metal elements. The main metal component of the outer base electrode 312 is Cu.

As the distance from the outer surface of the multilayer body 2 to the measurement point increases, the content of Ni remains constant or substantially constant, and then starts decreasing at a certain point. Then, the content of Ni stops decreasing at another point, and remains constant or substantially constant. As the distance from the outer surface of the multilayer body 2 to the measurement point increases, the content of Cu remains constant or substantially constant, and then starts increasing at a certain point. Then, the content of Cu stops increasing at another point, and remains constant or substantially constant.

The point at which the content of the main metal component of the inner base electrode 311 (for example, Ni) is equal or substantially equal to the content of the main metal component of the outer base electrode 312 (for example, Cu) is the boundary point between the inner base electrode 311 and the outer base electrode 312.

The point at which the content of the main metal component of the outer base electrode 312 (for example, Cu) is about 1/10 of the content of the main metal component of the inner base electrode 311 (for example, Ni) is the boundary point between the inner diffusion portion 311a and a portion of the inner base electrode 311 other than the inner diffusion portion 311a. The region between the boundary point between the inner diffusion portion 311a and the portion of the inner base electrode 311 other than the inner diffusion portion 311a and the boundary point between the inner base electrode 311 and the outer base electrode 312 is the inner diffusion portion 311a.

The point at which the content of the main metal component of the inner base electrode 311 (for example, Ni) is about 1/10 of the content of the main metal component of the outer base electrode 312 (for example, Cu) is the boundary point between the outer diffusion portion 312a and a portion of the outer base electrode 312 other than the outer diffusion portion 312a. The region between the boundary point between the outer diffusion portion 312a and the portion of the outer base electrode 312 other than outer diffusion portion 312a and the boundary point between the inner base electrode 311 and the outer base electrode 312 is the outer diffusion portion 312a.

In FIG. 5, the minimum distance from the measurement point to the outer surface of the multilayer body 2 at the boundary point between the inner base electrode 311 and the outer base electrode 312 is indicated by “D1”. The minimum distance from the measurement point to the outer surface of the multilayer body 2 at the boundary point between the inner diffusion portion 311a and the portion of the inner base electrode 311 other than the inner diffusion portion 311a is indicated by “D2”. The minimum distance from the measurement point to the outer surface of the multilayer body 2 at the boundary point between the outer diffusion portion 312a and the portion of the outer base electrode 312 other than the outer diffusion portion 312a is indicated by “D3”.

The above-described EDX analysis is successively performed while moving the position in the lamination direction T. Thus, a boundary line between the inner base electrode 311 and the outer base electrode 312, a boundary line between the inner diffusion portion 311a and the portion of the inner base electrode 311 other than the inner diffusion portion 311a, and a boundary line between the outer diffusion portion 312a and the portion of the outer base electrode 312 other than the outer diffusion portion 312a can be obtained.

The boundary lines obtained by the above-described method may be disconnected in regions overlapping glass. Portions of the boundary lines that are disconnected due to glass are connected with shortest line segments.

Alternatively, for example, the areas of the inner base electrode 311, the outer base electrode 312, the inner diffusion portion 311a, and the outer diffusion portion 312a may be determined by the method described below.

In the predetermined cross section, the base electrode 311 is divided into a plurality of mesh segments. Each mesh segment is subjected to the EDX measurement. Thus, the contents of metal components are determined for each mesh segment. The main metal component of the inner base electrode 311 and the main metal component of the outer base electrode 312 are determined. The ratio between the main metal component of the inner base electrode 311 and the main metal component of outer base electrode 312 is calculated for each mesh segment. Based on the calculated ratio, whether the mesh segment belongs to the inner base electrode 311 or the outer base electrode 312 is determined, and whether or not the mesh segment belongs to the inner diffusion portion 311a or the outer diffusion portion 312a is determined.

The collection of the mesh segments determined to belong to the inner base electrode 311 is regarded as the inner base electrode 311. The collection of the mesh segments determined to belong to the outer base electrode 312 is regarded as the outer base electrode 312. The collection of the mesh segments determined to belong to the inner diffusion portion 311a of the inner base electrode 311 is regarded as the inner diffusion portion 311a. The collection of the mesh segments determined to belong to the outer diffusion portion 312a of the outer base electrode 312 is regarded as the outer diffusion portion 312a.

### Thickness of Inner Base Electrode and Thickness of Outer Base Electrode

The thickness of the inner base electrode 311 and the thickness of the outer base electrode 312 are determined in the LT cross section passing through the central portion of the multilayer ceramic capacitor 1 in the width direction W. The multilayer ceramic capacitor 1 is polished to expose a predetermined cross section. The thickness of the inner base electrode 311 and the thickness of the outer base electrode 312 can be determined by observing the predetermined cross section with a scanning electron microscope.

### Glass Content

The glass content is determined in the LT cross section passing through the central portion of the multilayer ceramic capacitor 1 in the width direction W. The multilayer ceramic capacitor 1 is polished to expose a predetermined cross section. The predetermined cross section is subjected to a WDX measurement to determine the glass content. The glass content is calculated by Equation (1) below. The target region based on which the glass content of the inner base electrode 311 is determined is the entirety or substantially the entirety of the inner base electrode 311 in the LT cross section passing through the central portion of the multilayer ceramic capacitor 1 in the width direction W. The target region based on which the glass content of the outer base electrode 312 is determined is the entirety or substantially the entirety of the outer base electrode 312 in the LT cross section passing through the central portion of the multilayer ceramic capacitor 1 in the width direction W. The area of glass is measured as the area of Si.

Equation 1

Glass Content (%)=Total Area of Si in Target Region/Total Area of Target Region×100 (1)

### Porosity

The porosity is measured in a cross section of one of the dielectric layers 14 along a plane parallel or substantially parallel to the length direction L and the width direction W. The multilayer body is polished to expose a predetermined cross section. The porosity can be determined by calculating the percentage of the area occupied by the pores in the predetermined cross section. An image of the predetermined cross section is captured by a scanning electron microscope (SEM). The obtained SEM image is analyzed to determine the area of the field of view and the area occupied by the pores. The porosity is calculated by the determined areas and Equation (2). The region in which the image is captured by the SEM is a portion of the dielectric layer 14 provided between the inner electrodes 15 that are adjacent to each other, more specifically, a central region of the portion in the length direction L and the width direction W. When the image is captured, the magnification is set so that the viewing angle is covered by a plate of about 12 μm×about 9 μm.

Equation 2

Porosity (%)=Area Occupied by Pores/Area of Field of View×100 (2)

### Displacements of End Portions of Inner Electrodes

The displacements in the width direction W of the end portions of the adjacent inner electrodes 15 in the width direction W can be measured by using an SEM.

More specifically, first, the multilayer ceramic capacitor is polished from the first end surface CA or the second end surface CB to the central portion of the multilayer ceramic capacitor in the length direction L to expose a WT cross section. Next, the WT cross section is observed with the SEM. The observation conditions are: a magnification of about 2000× and an accelerating voltage of about 5 kV. An image of the end portions of the inner electrodes 15 in the width direction W is captured with a field of view of about 50 μm×about 50 μm in upper, lower, and central regions in the lamination direction T. The image is captured under the above-described observation conditions, and the distances between the end portions of the adjacent inner electrodes 15 in the width direction W are measured using a scale in the SEM image. Thus, the displacements of the adjacent inner electrodes 15 in the width direction W can be determined.

### Dimensions of Multilayer Body

The outer dimensions of the multilayer ceramic capacitor 1 can be measured by using a micrometer.

### Method for Manufacturing Multilayer Ceramic Capacitor 1

An example of a method for manufacturing the multilayer ceramic capacitor 1 according to the example embodiment will now be described.

### Printing Step

First, ceramic green sheets obtained by shaping ceramic slurry into sheets are prepared. The ceramic green sheets include a ceramic raw material including a dielectric ceramic material and other materials, such as a binder and a solvent. An additive including rare-earth may be added to the ceramic raw material. Next, conductive paste for the inner electrodes is prepared. The conductive paste for the inner electrodes includes metal powder and other materials, such as a binder and a solvent.

Next, the conductive paste for the inner electrodes is printed on the ceramic green sheets. The conductive paste for the inner electrodes is print by, for example, screen printing or gravure printing. The conductive paste for the inner electrodes is printed in a plurality of regions at intervals in the length direction L. The conductive paste for the inner electrodes is printed in a striped pattern extending in the width direction W. Thus, ceramic green sheets for the inner layer portion are obtained.

Ceramic green sheets on which no inner electrode patterns are printed are prepared as ceramic green sheets for the outer layer portions. The ceramic green sheets for the inner layer portion may include components different from components included in the ceramic green sheets for the outer layer portions.

### Stacking Step

A predetermined number of ceramic green sheets for the outer layer portions are stacked. A predetermined number of ceramic green sheets for the inner layer portion are stacked. Next, the ceramic green sheets for the inner layer portion are stacked with alternate displacements in the length direction L. Next, a predetermined number of ceramic green sheets for the outer layer portions are stacked. Next, ceramic green sheets for the outer layer portions are stacked on both sides of the stack of ceramic green sheets for the inner layer portion in the lamination direction. The ceramic green sheets for the outer layer portions are bonded to the stack of ceramic green sheets for the inner layer portion by thermal pressure bonding, for example. Thus, a mother block is obtained. Each outer layer portion 12 may be a laminate of a plurality of ceramic green sheets or a single ceramic green sheet.

### Pressing Step

The mother block is pressed in the lamination direction T by, for example, isostatic pressing. A plate made of a hard material (for example, a steel plate) is pressed against the first principal surface AA of the mother block, and a plate made of a soft material (for example, rubber) is pressed against the second principal surface AB of the mother block. Thus, only some of the inner electrodes 15 that are positioned close to the first principal surface AA can be curved toward the second principal surface AB.

### Mother Block Cutting Step

Next, the mother block is cut along lines corresponding to the dimensions of the multilayer body 2. The mother block is, for example, cut by a press-cutting blade. The mother block is, for example, cut along the length direction L and the width direction W. Thus, a plurality of rectangular or substantially rectangular parallelepiped shaped blocks (referred to as “multilayer chips”) are obtained.

The curvature of the end portions of the inner electrodes 15 in the length direction L can also be formed by adjusting the cutting speed when the mother block is cut. The mother block is, for example, cut by a press-cutting blade. When the mother block is cut by a press-cutting blade or the like, the cutting speed may be set to a relatively high speed to curve the end portions of the inner electrodes 15 in the direction of movement of the press-cutting blade, and be set to a relatively low speed to reduce or prevent the curvature of the end portions of the inner electrodes 15. When the mother block is cut in the width direction W, the press-cutting blade is moved into the mother block from the first principal surface AA toward the second principal surface AB. The cutting speed is set to a relatively high speed in a region near the first principal surface AA, and to a relatively low speed in a region near the second principal surface AB. Thus, the end portions of the inner electrodes 15 in the length direction L can be curved toward the central portion of the multilayer chip in the lamination direction T in the region near the first principal surface AA, and the curvature of the inner electrodes 15 can be reduced or prevented in the region near the second principal surface AB. When the mother block is cut in the length direction L, the cutting speed is set to a relatively low speed. Thus, the curvature of the end portions of the inner electrodes 15 in the width direction W can be reduced or prevented.

### Rounding Step

The corner portions and the ridge portions of the multilayer chip are preferably rounded by, for example, barrel finishing.

### Side Margin Portion Forming Step

Ceramic green sheets for the side margin portions 20 are prepared. The ceramic green sheets for the side margin portions 20 include, for example, Si in addition to the components included in the ceramic green sheets for the dielectric layers 14. The ceramic green sheets for the side margin portions 20 may include additives such as, for example, Mg, Mn, Sn, Ho, or Tb. Next, the ceramic green sheets for the side margin portions 20 are attached to the outer surfaces of the multilayer chip at which the inner electrodes 15 are exposed (in other words, the faces opposed to each other in the width direction W). Thus, the side margin portions 20 are formed on the multilayer chip. The corner portions and the ridge portions of the multilayer chip are rounded prior to the side margin portion forming step. Therefore, the recessed portions 21 are formed at the boundaries between the multilayer chip and the side margin portions 20. Each side margin portion 20 may include a single ceramic green sheet or a plurality of ceramic green sheets.

Next, the multilayer chip on which the side margin portions 20 are formed is pressed in the width direction W. The multilayer chip on which the side margin portions 20 are formed is pressed more strongly at a central portion in the lamination direction T than at the end portions in the lamination direction T. Accordingly, the outer surfaces of the side margin portions 20 in the width direction W are curved inward toward the central portion of the multilayer chip in the width direction W. Similarly, the outer surfaces of the multilayer chip at which the inner electrodes 15 are exposed are also curved inward toward the central portion of the multilayer chip in the width direction W.

The central portions of the side margin portions 20 in the lamination direction T may be pressed toward the central portion of the multilayer body 2 in the width direction W to curve the entire side margin portions 20 in an arc shape such that the end portions of the side margin portions 20 in the lamination direction T are separated from the multilayer chip. Therefore, it is not necessary that the multilayer chip undergo a rounding process to form the recessed portions 21 at the boundaries between the multilayer chip and the side margin portions 20.

### Multilayer Body Firing Step

The multilayer chip is heated at a predetermined firing temperature for a predetermined time in a nitrogen atmosphere. Thus, the multilayer body 2 is obtained.

### Inner Base Electrode Forming Step

Conductive paste including glass and metal is prepared as conductive paste for the inner base electrode 311. The main metal component of the conductive paste for the inner base electrode 311 includes, for example, at least one metal of Ni, Ag, or Pd, and is, for example, Ni. The glass content of the conductive paste for the inner base electrode 311 is, for example, about 5 mass percent or more and about 10 mass percent or less of the total amount of conductive paste for the inner base electrode 311. Next, the conductive paste for the inner base electrode 311 is applied to each end surface C. Among the outer surfaces of the multilayer body 2, the conductive paste for the inner base electrode 311 is applied only to, for example, the end surfaces C. After the conductive paste for the inner base electrode 311 is dried, the multilayer body 2 to which the conductive paste for the inner base electrode 311 is applied is heated at a predetermined firing temperature for a predetermined time in, for example, a nitrogen atmosphere. The predetermined firing temperature is in the range of, for example, about 900 ° C. to about 1000 ° C. Thus, the conductive paste for the inner base electrode 311 is baked onto the multilayer body 2, so that the inner base electrode 311 is formed on the multilayer body 2.

### Outer Base Electrode Forming Step

Conductive paste including glass and metal is prepared as conductive paste for the outer base electrode 312. The main metal component of the conductive paste for the outer base electrode 312 is, for example, at least one metal of Cu, Sn, or Zn, and is, for example, Cu. The glass content of the conductive paste for the outer base electrode 312 is in the range of, for example, about 15 mass percent to about 30 mass percent of the total amount of conductive paste for the outer base electrode 312.

Next, the conductive paste for the outer base electrode 312 is applied to the inner base electrode 311. The conductive paste for the outer base electrode 312 is, for example, applied to cover the end surfaces C, portions of principal surfaces A, and portions of the side surfaces B. After the conductive paste for the outer base electrode 312 is dried, the multilayer body 2 to which the conductive paste for the outer base electrode 312 is applied is heated at a predetermined firing temperature for a predetermined time in a nitrogen atmosphere. The predetermined firing temperature is in the range of, for example, about 750° C. to about 850° C. Thus, the conductive paste for the outer base electrode 312 is baked onto the inner base electrode 311, so that the outer base electrode 312 is formed on the multilayer body 2.

When the outer base electrode 312 is baked, the components of the inner base electrode 311 are diffused into the outer base electrode 312, and the components of the outer base electrode 312 are diffused into the inner base electrode 311. Thus, the inner diffusion portion 311a is formed in the inner base electrode 311, and the outer diffusion portion 312a is formed in the outer base electrode 312.

Since the glass content of the conductive paste for the outer base electrode 312 is in the range of, for example, about 15 mass percent to about 30 mass percent of the total amount of conductive paste for the outer base electrode 312, the outer base electrode 312 can be baked at a relatively low baking temperature. Therefore, excessive diffusion of the components of the inner base electrode 311 into the outer base electrode 312 can be reduced or prevented.

The arrangement of the conductive paste is not limited to this. The conductive paste for the inner base electrode 311 may be applied to extend to the principal surfaces A and the side surfaces B. Alternatively, the conductive paste for the inner base electrode 311 and the conductive paste for the outer base electrode 312 may both be formed only on the end surfaces C among the outer surfaces of the multilayer body 2.

### Plating Step

The plating layer 32 is formed on the base electrode 31. First, the first plating layer 321 is formed on the base electrode 31. Next, the second plating layer 322 is formed on the first plating layer 321. The first plating layer 321 is, for example, formed by Ni plating. The second plating layer 322 is, for example, formed by Sn plating. The first plating layer 321 and the second plating layer 322 are, for example, successively formed by electrolytic plating.

The multilayer ceramic capacitor 1 illustrated in FIG. 1 is formed by the above-described method.

### Advantageous Effects of Example Embodiment

The present example embodiment provides the following advantageous effects.

According to the present example embodiment, the outer base electrode 312 includes the outer diffusion portion 312a that is a region including the main metal component of the inner base electrode 311 with a content of, for example, about 1/10 or more of the content of the main metal component of the outer base electrode 312 in the outer base electrode 312. The outer diffusion portion 312a is adjacent to the inner base electrode 311. The outer diffusion portion 312a has a maximum thickness of, for example, about 1.0 μm or less.

According to the above-described structure, since the main metal component of the inner base electrode 311 and the main metal component of the outer base electrode 312 differ from each other, the inner base electrode 311 and the outer base electrode 312 may have different functions. Therefore, the inner base electrode 311 may include a main metal component that facilitates connection to the inner electrodes 15 so that the connection between the inner base electrode 311 and the inner electrodes 15 can be enhanced. The outer base electrode 312 may include a main metal component that facilitates the reduction or prevention of corrosive infiltration so that the infiltration of corrosives included in a plating solution for the plating layer 32 into the multilayer body 2 can be reduced or prevented.

The diffusion of the main metal component of the inner base electrode 311 into the outer base electrode 312 may cause a reduction in the corrosion resistance of the outer base electrode 312. However, since the outer diffusion portion 312a has a maximum thickness of about 1.0 μm or less, the infiltration of corrosives into the multilayer body 2 can be sufficiently reduced or prevented by the outer base electrode 312.

Therefore, the reliability regarding electrical connection and the reliability regarding resistance to corrosives can both be improved, and the multilayer ceramic capacitor 1 with improved reliability can be provided.

According to the present example embodiment, the main metal component of the inner base electrode 311 is, for example, preferably at least one metal of Ni, Ag, or Pd, and the main metal component of the outer base electrode 312 is, for example, preferably at least one metal of Cu, Sn, or Zn.

According to this structure, the connection between the inner base electrode 311 and the inner electrodes 15 can be more appropriately improved. The infiltration of corrosives into the multilayer body 2 can be more appropriately reduced or prevented by the outer base electrode 312.

According to the present example embodiment, the inner base electrode 311 has a maximum thickness less than the maximum thickness of the outer base electrode 312.

According to this structure, the diffusion of the main metal component of the inner base electrode 311 into the outer base electrode 312 can be reduced or prevented. Therefore, a reduction in the function of reducing or preventing corrosive infiltration provided by the outer base electrode 312 can be reduced or prevented.

According to the present example embodiment, the ratio of the maximum thickness of the inner base electrode 311 to the maximum thickness of the outer base electrode 312 is 0.5 or more and 0.9 or less.

According to this structure, a reduction in the function of reducing or preventing corrosive infiltration provided by the outer base electrode 312 can be reduced or prevented.

When the main metal component of the outer base electrode 312 is a metal that readily forms an alloy with the main metal component of the inner electrodes 15, for example, when the main metal component of the outer base electrode 312 is Cu and the main metal component of the inner electrodes 15 is Ni, the main metal component of the outer base electrode 312 and the main metal component of the inner electrodes 15 may form an alloy if the main metal component of the outer base electrode 312 reaches the multilayer body 2 through the inner base electrode 311. If the thus-formed alloy expands, cracks may be formed in the multilayer body 2.

However, according to the above-described structure, the inner base electrode 311 is relatively thick, so that the main metal component of the outer base electrode 312 does not easily reach the multilayer body 2 through the inner base electrode 311. Therefore, the occurrence of cracks in the multilayer body 2 can be reduced or prevented.

According to the present example embodiment, the glass content of the inner base electrode 311 is less than the glass content of the outer base electrode 312.

According to this structure, since the glass content of the outer base electrode 312 is high, the outer base electrode 312 can be baked at a low temperature. Therefore, when the outer base electrode 312 is baked, the main metal component (for example, Cu) of the outer base electrode 312 can be diffused into the inner base electrode 311, and the main metal component (for example, Ni) of the inner base electrode 311 can be diffused into the outer base electrode 312. As a result, a reduction in the content of the main metal component of the outer base electrode 312 in the outer base electrode 312 can be reduced or prevented, so that a reduction in the function of reducing or preventing corrosive infiltration provided by the outer base electrode 312 can be reduced or prevented. In addition, a reduction in the content of the main metal component of the inner base electrode 311 in the inner base electrode 311 can be reduced or prevented, so that a reduction in the connection between the inner base electrode 311 and the inner electrodes 15 can be reduced or prevented.

According to the present example embodiment, the ratio of the glass content of the inner base electrode 311 to the glass content of the outer base electrode 312 is, for example, about 0.33 or more and about 0.66 or less.

When the ratio of the glass content of the inner base electrode 311 to the glass content of the outer base electrode 312 is excessively high, the sintering temperature of the outer base electrode 312 may be excessively high relative to the sintering temperature of the inner base electrode 311, and there is a possibility that the outer base electrode 312 cannot be sufficiently sintered only by sintering at a low temperature. When the ratio of the glass content of the inner base electrode 311 to the glass content of the outer base electrode 312 is excessively low, the glass content of the outer base electrode 312 may be excessively high, and the outer base electrode 312 may have an excessively high resistance value (ESR). However, according to the above-described structure, the outer base electrode 312 can be sufficiently sintered, and an excessive increase in the ESR can be reduced or prevented.

According to the present example embodiment, when a portion of the inner base electrode 311 provided on the first end surface CA is evenly divided into three regions in the length direction L in a LT cross section, the glass content in one of the three regions that is closest to the outer base electrode 312 is greater than the glass content in the central one of the three regions.

According to this structure, the diffusion of the main component of the inner base electrode 311 from the inner base electrode 311 to the outer base electrode 312 can be appropriately reduced or prevented by the glass present at the boundary between the inner base electrode 311 and the outer base electrode 312. In addition, since the glass present at the boundary between the inner base electrode 311 and the outer base electrode 312 defines and functions as an anchor, the adhesion between the inner base electrode 311 and the outer base electrode 312 can be increased.

According to the present example embodiment, in the WT cross section of the multilayer body 2, the inner electrodes 15 satisfy a relationship in which end portions of every adjacent pair of the inner electrodes 15 on one side in the width direction W are at a distance of, for example, about 0.5 μm or less from each other in the width direction W. The inner electrodes 15 satisfy a relationship in which end portions of every adjacent pair of the inner electrodes 15 on the other side in the width direction W are at a distance of, for example, about 0.5 μm or less from each other in the width direction W.

According to this structure, the ends of the inner electrodes 15 on one side in the width direction W are aligned in the lamination direction T, so that the capacitance of the multilayer ceramic capacitor 1 can be accurately set.

According to the present example embodiment, the multilayer body 2 includes the recessed portions 21 in the outer surfaces of the multilayer body 2 in regions overlapping, in the lamination direction T, the end portions of the inner electrodes 15 in the width direction W. The recessed portions 21 are recessed toward a central portion of the multilayer body 2 in the lamination direction T.

According to this structure, the inner base electrode 311 or the outer base electrode 312 may be wedged into the recessed portions 21, so that the separation of end portions of the inner base electrode 311 or the outer base electrode 312 can be reduced or prevented.

According to the present example embodiment, the dielectric layers 14 preferably have a porosity of, for example, about 1% or more and about 5% or less.

According to this structure, since the dielectric layers 14 have a moderately high porosity, the inner electrodes 15 can be readily wedged into the pores in the dielectric layers 14, so that the interlayer separation of the inner electrodes 15 can be reduced or prevented. In addition, since the dielectric layers 14 have a moderately low porosity, the occurrence of cracks in the multilayer body 2 can be reduced or prevented.

According to the present example embodiment, in a WT cross section passing through the central portion of the multilayer body 2 in the length direction L, the dimension of the multilayer body 2 in the width direction W at the central portion of the multilayer body 2 in the lamination direction T is less than the dimensions of the multilayer body 2 in the width direction W at the end portions of the multilayer body 2 in the lamination direction T.

According to this structure, the flexural strength of the multilayer body 2 in a direction perpendicular or substantially perpendicular to the substrate can be increased.

According to the present example embodiment, in an LT cross section passing through the central portion of the multilayer body 2 in the width direction W, the extended portion 15b of one of the inner electrodes 15 that is closest to the first principal surface AA has a curvature greater than the curvature of the extended portion 15b of one of the inner electrodes 15 that is closest to the second principal surface AB.

When the multilayer ceramic capacitor 1 is mounted, a portion of the multilayer body 2 that is closer to the substrate tends to undergo a higher stress than a portion of the multilayer body 2 that is farther from the substrate. According to the above-described structure, when the multilayer ceramic capacitor 1 is mounted on the substrate such that the second principal surface AB faces the substrate, the inner electrode 15 having a smaller curvature is disposed in a region of the multilayer body 2 that is adjacent to the substrate. As the curvature of the inner electrode 15 decreases, the strength of the inner electrode 15 increases. Thus, the inner electrode 15 that is strong can be disposed in the region of the multilayer body 2 in which the multilayer body 2 tends to undergo a relatively high stress. Therefore, when the multilayer ceramic capacitor 1 is mounted, the occurrence of defects in the multilayer body 2 due to bending of the substrate can be reduced or prevented.

In addition, according to this structure, when the multilayer ceramic capacitor 1 is mounted on the substrate such that the second principal surface AB faces the substrate, the inner electrode 15 having a greater curvature is disposed in a region of the multilayer body 2 that is far from the substrate. The adhesion between the inner electrode 15 and the dielectric layers 14 can be increased by curving the inner electrode 15. Therefore, the separation of the inner electrode 15 can be reduced or prevented in the region of the multilayer body 2 in which the multilayer body 2 tends to undergo a relatively low stress.

According to the present example embodiment, the dimension of the multilayer body 2 in the lamination direction T is greater than the dimension of the multilayer body 2 in the width direction W.

According to this structure, the number of the inner electrodes 15 can be increased. Therefore, the multilayer ceramic capacitor 1 with an increased capacitance can be provided.

In addition, the lamination direction T and the width direction W can be easily distinguished from each other, so that the multilayer ceramic capacitor 1 can be easily mounted on the substrate in the desired orientation.

Although example embodiments of the present invention have been described, the present invention is not limited to the above-described example embodiment, and various alterations and modifications are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including dielectric layers and inner electrodes, a first principal surface and a second principal surface opposed to each other in a lamination direction, a first side surface and a second side surface opposed to each other in a width direction crossing the lamination direction, and a first end surface and a second end surface opposed to each other in a length direction crossing the lamination direction and the width direction; and
an outer electrode on the multilayer body and connected to the inner electrodes; wherein
the outer electrode includes:
an inner base electrode on at least one of the first end surface and the second end surface and including glass and conductive metal;
an outer base electrode on the inner base electrode and including glass and conductive metal and including, as a main metal component, a metal component different from a main metal component of the inner base electrode; and
a plating layer on the outer base electrode;
the outer base electrode includes an outer diffusion portion including the main metal component of the inner base electrode with a content of about 1/10 or more of a content of the main metal component of the outer base electrode in the outer base electrode;
the outer diffusion portion is adjacent to the inner base electrode; and
the outer diffusion portion has a maximum thickness of about 1.0 μm or less.

2. The multilayer ceramic capacitor according to claim 1, wherein
the main metal component of the inner base electrode includes at least one of Ni, Ag, or Pd; and
the main metal component of the outer base electrode includes at least one of Cu, Sn, or Zn.

3. The multilayer ceramic capacitor according to claim 1, wherein the inner base electrode has a maximum thickness less than a maximum thickness of the outer base electrode.

4. The multilayer ceramic capacitor according to claim 3, wherein a ratio of the maximum thickness of the inner base electrode to the maximum thickness of the outer base electrode is about 0.5 or more and about 0.9 or less.

5. The multilayer ceramic capacitor according to claim 1, wherein, in a cross section of the multilayer body along a plane parallel or substantially parallel to the lamination direction and the width direction, the inner electrodes satisfy a relationship in which end portions of every adjacent pair of the inner electrodes on one side in the width direction are at a distance of about 0.5 μm or less from each other in the width direction, and a relationship in which end portions of every adjacent pair of the inner electrodes on other side in the width direction are at a distance of about 0.5 μm or less from each other in the width direction.

6. The multilayer ceramic capacitor according to claim 1, wherein the multilayer body includes a recessed portion on an outer surface of the multilayer body in a region overlapping, in the lamination direction, end portions of the inner electrodes in the width direction, the recessed portion being recessed toward a central portion of the multilayer body in the lamination direction.

7. The multilayer ceramic capacitor according to claim 1, wherein the dielectric layers have a porosity of about 1% or more and about 5% or less.

8. The multilayer ceramic capacitor according to claim 1, wherein a dimension of the multilayer body in the width direction at a central portion of the multilayer body in the lamination direction is less than dimensions of the multilayer body in the width direction at end portions of the multilayer body in the lamination direction.

9. The multilayer ceramic capacitor according to claim 1, wherein
each of the inner electrodes includes a facing portion and an extended portion, the facing portion of each inner electrode facing another one of the inner electrodes that is adjacent to the inner electrode in the lamination direction, the extended portion extending from the facing portion toward the outer electrode; and
in a cross section of a central portion of the multilayer body in the width direction along a plane parallel or substantially parallel to the length direction and the lamination direction, the extended portion of one of the inner electrodes that is closest to the first principal surface has a curvature greater than a curvature of the extended portion of one of the inner electrodes that is closest to the second principal surface.

10. The multilayer ceramic capacitor according to claim 1, wherein a dimension of the multilayer body in the lamination direction is greater than a dimension of the multilayer body in the width direction.

11. The multilayer ceramic capacitor according to claim 5, wherein
the main metal component of the inner base electrode includes at least one of Ni, Ag, or Pd; and
the main metal component of the outer base electrode includes at least one of Cu, Sn, or Zn.

12. The multilayer ceramic capacitor according to claim 5, wherein the inner base electrode has a maximum thickness less than a maximum thickness of the outer base electrode.

13. The multilayer ceramic capacitor according to claim 5, wherein the multilayer body includes a recessed portion on an outer surface of the multilayer body in a region overlapping, in the lamination direction, end portions of the inner electrodes in the width direction, the recessed portion being recessed toward a central portion of the multilayer body in the lamination direction.

14. The multilayer ceramic capacitor according to claim 5, wherein a dimension of the multilayer body in the width direction at a central portion of the multilayer body in the lamination direction is less than dimensions of the multilayer body in the width direction at end portions of the multilayer body in the lamination direction.

15. The multilayer ceramic capacitor according to claim 5, wherein
each of the inner electrodes includes a facing portion and an extended portion, the facing portion of each inner electrode facing another one of the inner electrodes that is adjacent to the inner electrode in the lamination direction, the extended portion extending from the facing portion toward the outer electrode; and
in a cross section of a central portion of the multilayer body in the width direction along a plane parallel or substantially parallel to the length direction and the lamination direction, the extended portion of one of the inner electrodes that is closest to the first principal surface has a curvature greater than a curvature of the extended portion of one of the inner electrodes that is closest to the second principal surface.

16. The multilayer ceramic capacitor according to claim 5, wherein a dimension of the multilayer body in the lamination direction is greater than a dimension of the multilayer body in the width direction.
